(19) United States
(12) Patent Application Publication
(10) Pub. No.: US 2026/0291274 A1
(43) Pub. Date: Sep. 24, 2026

(54) GRAPH-BASED CONNECTIVITY MODEL FOR ELECTRICITY DISTRIBUTION GRIDS

(71) Applicant: Camus Energy Inc, Campbell, CA (US)

(72) Inventors: Akhilesh Bakshi, Issaquah, WA (US); Nicholas Laws, Golden, CO (US); Dylan Cutler, Boulder, CO (US); Emma Elgqvist, Golden, CO (US)

(21) Appl. No.: 19/397,749

(22) Filed: Nov. 21, 2025

Related U.S. Application Data
(60) Provisional application No. 63/725,339, filed on Nov. 26, 2024.

(51) Int. Cl. H02J 13/10; H02J 13/12; H04L 41/28

(52) U.S. Cl. CPC H02J 13/10; H02J 13/12; H04L 41/28

(57) ABSTRACT

A computer-implemented system and method are disclosed for constructing, maintaining, and utilizing a graph-based connectivity model of an electric power distribution network. The system ingests heterogeneous datasets describing electrical assets from geographic information systems, customer information systems, interconnection records, and telemetry streams. The data are canonicalized into standardized resource objects representing physical and logical elements of the grid. A connectivity builder automatically constructs a topological graph comprising nodes and edges that model electrical relationships, detects disconnected subgraphs, and merges them based on geometric and electrical compatibility. The resulting unified graph is stored in a distributed database and dynamically updated in response to switch-state telemetry, enabling real-time representation of network topology. Analytical, forecasting, and control services operate upon the graph to compute power flows, reliability indices, and control actions, providing utilities with a continuously updated, scalable, and data-driven model of their electrical distribution systems.

### CROSS-REFERENCE TO RELATED APPLICATIONS

This application claims the benefit of and priority to U.S. Provisional Patent Application No. 63/725,339 filed on Nov. 26, 2024, the disclosure of which is hereby incorporated by reference in its entirety for all purposes.

### TECHNICAL FIELD

This application generally relates to the electricity grid management platform, and more particularly to methods and systems for a graph-based connectivity model to represent all the electricity grid components included in the electricity grid management platform.

### BACKGROUND

Electric power distribution networks are undergoing rapid transformation due to the widespread deployment of distributed energy resources, including solar photovoltaic systems, battery energy storage units, and electric vehicle charging infrastructure. This evolution has introduced significant challenges in representing, managing, and operating electricity grids in a consistent and scalable manner.

One primary technical problem arises from the fragmented and inconsistent nature of grid data across existing utility systems. Information concerning assets, customers, and electrical connectivity is typically dispersed among various platforms such as geographic information systems (GIS), customer information systems (CIS), and advanced distribution management systems (ADMS). Each of these platforms maintains its own data formats, structures, and naming conventions, which are often mutually incompatible. As a result, constructing a single unified view of the electrical network becomes exceedingly difficult. In many cases, critical connectivity relationships are missing or incorrect, leading to data gaps and logical inconsistencies that impair downstream analytics and control operations.

Another technical problem is the inability of existing modeling approaches to capture the dynamic behavior of power distribution networks. The topology of a distribution system may change in real time in response to switching actions, fault isolations, or distributed generation events. Existing modeling techniques are typically static and do not account for these transient states, making it impossible for operators to reliably determine electrical paths, voltage conditions, or power flow distributions under evolving grid conditions. Consequently, existing systems are unable to provide accurate situational awareness or enable autonomous control based on up-to-date topology information.

Moreover, traditional grid models lack interoperability and scalability in modern computing environments. Because data schemas and algorithms vary from one utility to another, existing tools cannot easily be extended or generalized to other systems. Many existing platforms also fail to leverage cloud or distributed computing, thereby limiting the ability to process large-scale connectivity graphs or perform real-time analytics at the scale required for modern utilities.

Finally, current systems offer limited support for integrating cyber-physical data, predictive analytics, or artificial intelligence techniques to enhance grid reliability and situational awareness. The absence of such integration prevents utilities from developing proactive operational strategies and constrains their ability to optimize asset utilization and system resilience.

Collectively, these deficiencies underscore a pressing need for a comprehensive, extensible, and automated framework capable of unifying disparate grid data, constructing complete and accurate connectivity models, and maintaining those models dynamically as the grid evolves, so as to enable autonomous control based on up-to-date topology information.

### SUMMARY

To address the aforementioned shortcomings, a method and a system for constructing, maintaining, and utilizing a dynamic graph-based connectivity model of an electrical distribution network are provided.

In one aspect, the present disclosure provides an electricity grid management system, including a processor; and a memory, coupled to the processor, configured to store executable instructions that, when executed by the processor, cause the processor to ingest heterogeneous datasets describing electrical resources of a distribution network from a plurality of data sources including geographic information systems, customer information systems, interconnection applications, and telemetry streams; canonicalize the ingested datasets into standardized resource objects each representing a physical or logical element of the distribution network, the resource objects including attributes defining at least a location, an electrical rating, and a connectivity identifier; construct, using the resource objects, a topological graph including nodes representing electrical buses and edges representing electrical connections between the buses; detect a plurality of disconnected subgraphs within the topological graph and merge the subgraphs based at least in part on geometric proximity and electrical phase compatibility to form a unified connected graph; store the unified connected graph in a graph database accessible to one or more analytical and control services; and dynamically update the unified connected graph responsive to telemetry events indicating a change in state of one or more switching devices in the distribution network.

In another aspect, the present disclosure provides a method for electricity grid management, including receiving, by one or more processors, datasets describing grid components from a plurality of disparate data sources; transforming the datasets into canonicalized resource objects representing electrical equipment and attributes of the resource objects; constructing, from the resource objects, a topological graph representing electrical connectivity among grid nodes; detecting multiple subgraphs within the topological graph and merging the subgraphs using geometric and electrical compatibility criteria; and updating the unified topological graph responsive to switch-state telemetry to reflect current operating topology.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1 illustrates an example end-to-end pipeline in the life cycle of graph-based connectivity models, according to some embodiments of the present disclosure.

FIG. 2 illustrates an example process of constructing a topological graph, according to some embodiments.

FIGS. 3 and 4 illustrate an example process for merging subgraphs into a unified connectivity model, according to some embodiments of the disclosure.

FIG. 5 illustrates an example geometrical graph for a simple distribution feeder composed of multiple resources, according to some embodiments of the disclosure.

FIG. 6 illustrates an example of a five-bus topological graph, according to some embodiments of the disclosure.

FIG. 7 illustrates the topological graph presented in FIG. 6 in a data payload or serialized format, according to some embodiments of the disclosure.

FIG. 8 illustrates how switch states may influence or alter the configuration of topological graphs, according to some embodiments of the disclosure.

FIG. 9 is a block diagram of an example computer for implementing the technology disclosed herein, according to an embodiment of the disclosure.

### DETAILED DESCRIPTION

The Figures (FIGS.) and the following description relate to some embodiments by way of illustration only. It should be noted that from the following discussion, alternative embodiments of the structures and methods disclosed herein will be readily recognized as viable alternatives that may be employed without departing from the principles of the disclosure.

Reference will now be made in detail to several embodiments, examples of which are illustrated in the accompanying figures. It is noted that wherever similar or like reference numbers may be used in the figures, they may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Motivation and Technical Benefits

As described above, modern electric-utility systems face a persistent and technically complex challenge: the inability to maintain an accurate, complete, and real-time representation of the electrical connectivity of distribution-grid assets. Existing database architectures and modeling tools are unable to efficiently reconcile heterogeneous, incomplete, or conflicting data from GIS, CIS, SCADA, and distributed energy resource (DER) telemetry. These legacy systems require manual intervention and static model updates, which result in time-lagged, error-prone connectivity information that cannot support real-time analysis or control. As a result, utilities lack a technically reliable means for continuously correlating field device states with the actual electrical topology of the grid.

The present disclosure provides a concrete and computer-implemented technical solution to these long-standing problems. The disclosure introduces a distributed computing framework that automatically transforms disparate utility data into standardized digital “resource” objects and constructs a machine-readable topological graph that mathematically models the electrical interconnections among those resources. The graph is not a mere visualization or data correlation, but a dynamic, executable data structure maintained by computer logic that supports real-time computation, traversal, and simulation. The disclosure further includes a subgraph-merging algorithm that uses spatial indexing, phasing information, and electrical plausibility scoring to automatically reconcile missing or inconsistent connectivity, thereby achieving a complete and validated electrical network model without manual engineering input.

Unlike existing systems that simply store tabular connectivity or visual schematics, the disclosed system uses a graph-database architecture with distributed memory and event-driven synchronization to maintain topological integrity as the physical grid changes. Each switch-state event, received as telemetry from field devices, triggers automatic graph-mutation routines that update the connectivity model within milliseconds, allowing downstream analytical and control applications to operate on a continuously accurate representation of the network. These operations are performed by processors executing specialized algorithms and data-management routines that directly improve the functioning of the computer itself, specifically, by reducing computation time for connectivity reconciliation from hours to seconds and enabling high-volume real-time data ingestion and analysis.

The methods and systems described in this disclosure thus introduce significant technical advantages and improvements in the automated management of electric power distribution networks. The disclosed connectivity model eliminates the long-standing dependency on manual data reconciliation and static modeling techniques by automatically ingesting, validating, and integrating data from diverse and uncoordinated sources. Through the use of graph-based representations, the system transforms fragmented and heterogeneous utility datasets into a single, unified digital model that reflects the real-time electrical state of the electricity grid. This automation drastically reduces human intervention, improves accuracy, and enables continuous synchronization between the physical network and its digital counterpart.

One key technical improvement achieved by the disclosure is the creation of a self-updating, machine-readable connectivity model that serves as a “living digital twin” of the actual electricity grid. The model continuously evolves as operational data is received from sensors, meters, and control devices deployed across the network. When switching events occur, new DERs are connected, or components are de-energized, the system automatically reconfigures the graph topology to maintain an accurate and up-to-date representation of electrical connectivity. This dynamic adaptation enables autonomous and near real-time analyses such as fault localization, feeder reconfiguration, and voltage optimization, functions that traditionally required manual intervention and offline studies. The cloud-based architecture of the disclosed system allows these computations to be executed in parallel across distributed processing environments, thereby supporting large-scale grid operations involving millions of devices.

Another major improvement provided by the disclosed platform lies in its integration of artificial intelligence and physics-based reasoning directly within the graph data structure. The system applies data-driven inference algorithms to detect missing or inconsistent connectivity relationships, validate phase and impedance data, and predict the likely configuration of unknown portions of the network. This capability not only corrects data deficiencies but also allows the system to anticipate and prevent operational anomalies before they occur. By combining real-time telemetry with predictive analytics, the platform supports autonomous decision-making for grid optimization, load balancing, and outage management. The result is a significant advancement over existing grid management systems that are static, fragmented, and incapable of supporting continuous automated operation.

The technical improvements embodied in the present disclosure therefore extend beyond enhanced data management to encompass the automation, scalability, and intelligence of the grid itself. By maintaining a continuously updated and computationally efficient digital representation of the power distribution network, the system provides a foundation for advanced control and optimization applications, including distributed energy resource coordination, adaptive protection schemes, and predictive maintenance scheduling. The combination of graph-based modeling, distributed computation, and AI-assisted inference transforms traditional utility operations into a data-driven, automated environment capable of responding dynamically to changes in grid conditions. This level of automation and self-correction represents a substantive technical advance in the field of electric power distribution management systems.

It should be understood that the foregoing advantages are exemplary and not exhaustive. Additional features, capabilities, and performance benefits of the disclosed system will be apparent to those skilled in the art upon review of the detailed embodiments, accompanying figures, and further descriptions provided herein.

### Overview of System Architecture

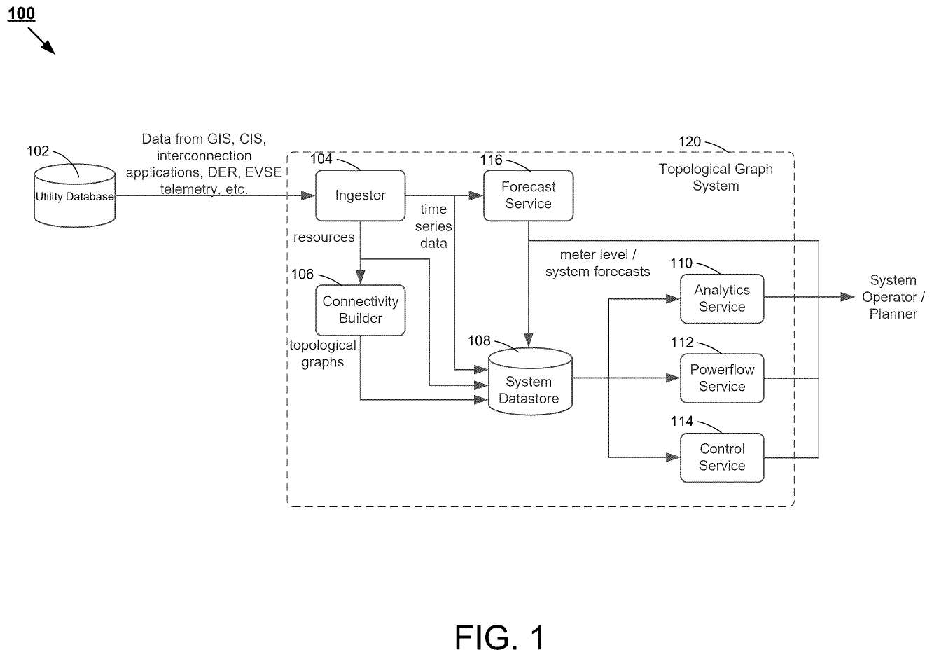

Referring now to FIG. 1, an embodiment of an end-to-end pipeline 100 is illustrated, depicting the life cycle of graph-based connectivity models and their integration with the functional components of a power distribution management platform. The architecture shown may be implemented in a cloud-based, containerized computing environment, comprising multiple intercommunicating software services that execute cooperatively to construct, maintain, and utilize a comprehensive graph representation of an electricity grid.

In one embodiment, the architecture may include a utility database 102, which may serve as an initial data repository containing raw information related to grid assets, customers, and operations. This database may exist within a utility's internal IT systems and may include a mixture of relational databases, GIS servers, and telemetry systems. Data from these systems may be extracted by an ingestor 104, which may be implemented as a distributed microservice responsible for canonicalizing the heterogeneous data formats.

The ingestor 104 may include a parser module, a schema-mapping engine, and a validation layer. The parser module may interpret incoming data feeds that may be structured in various formats such as JSON, XML, CSV, or proprietary relational tables. The schema-mapping engine may convert each record into a canonical “resource” format. Each resource may be represented internally as a data object stored in a distributed key-value or document-oriented database, such as Apache® Cassandra, MongoDB®, or Amazon® DynamoDB, and may include standardized fields for unique identifiers, geographic coordinates, electrical ratings, and operational states.

In some embodiments, each resource object may be defined by a structured data schema that includes, but is not limited to, the following attributes: type (e.g., conductor, meter, switch, transformer, regulator, capacitor, photovoltaic inverter, or distributed energy storage device); location (e.g., latitude, longitude, elevation, and coordinate reference system); connectivity identifiers (e.g., upstream and downstream node IDs or associated bus identifiers); electrical parameters (e.g., impedance, phasing, rated voltage, rated power, and thermal limits); and telemetry metadata (e.g., data source, timestamp of last update, and quality score).

Each resource may further include one or more foreign key references linking it to time-series measurement tables or external telemetry streams. For example, a meter resource may maintain a pointer to a telemetry topic in a message bus system, such as Kafka® or message queuing telemetry transport (MQTT), through which real-time consumption or voltage data may be received.

Once canonicalized, these resource objects may be streamed to a connectivity builder 106, which may be implemented as a cluster of stateless services operating on a distributed computing framework such as Apache® Spark, Ray®, or Dask®. The connectivity builder 106 may receive batches of resource objects, partition them by feeder or substation identifiers, and construct in-memory graph structures for each partition. The builder may perform this operation in parallel across nodes in a compute cluster, using map-reduce patterns to ensure scalability when processing millions of records.

The connectivity builder 106 may generate two distinct but related models: a geometrical graph, which represents spatial relationships between grid assets, and a topological graph, which represents electrical relationships independent of geography. The topological graph may be stored as an adjacency list or adjacency matrix in a graph database such as Neo4j®, JanusGraph, or Amazon® Neptune. Each node and edge within the graph database may maintain references to the corresponding canonical resource objects stored in the underlying datastore.

In one embodiment, the system datastore 108 may include multiple layers: a graph database layer for storing network topology, a time-series database (e.g., InfluxDB® or TimescaleDB® ) for storing telemetry data, and a metadata registry that records schema versions, ingestion timestamps, and data lineage for auditability. The datastore 108 may be optimized for read-heavy workloads, enabling downstream services to perform large-scale analytical queries without performance degradation.

The analytics service 110 may operate as an application layer responsible for processing data derived from the topological graph. It may execute algorithms for fault detection, load aggregation, and DER hosting capacity analysis. The analytics service may access the graph database through an API gateway, executing graph traversal queries using a standardized query language such as Gremlin® or Cypher®. Analytical operations may be distributed using container orchestration platforms such as Kubernetes®, allowing automatic scaling based on computational demand.

The powerflow service 112 may execute numerical simulations of the electrical network, computing voltages, currents, and power flows at each node. In some embodiments, this service may include a power-flow solver engine implemented in Python®, C++, or Julia®, interfaced through an application programming interface (API). The solver may import connectivity and parameter data directly from the topological graph, automatically building system matrices that represent the impedance and admittance between nodes. The system may solve the resulting equations using iterative numerical methods such as Newton-Raphson, Gauss-Seidel, or fast decoupled load flow algorithms.

The control service 114 may implement feedback mechanisms that act upon results from the analytics and powerflow services. It may issue control signals to field devices such as switches, voltage regulators, or distributed energy resources via secure protocols like DNP3, IEC 61850, or MQTT over transport layer security (TLS). Control actions may be scheduled or real-time, depending on operational constraints and regulatory requirements.

In parallel, the forecast service 116 may apply statistical and machine-learning algorithms to historical time-series data to predict load, generation, or network stress for future time intervals. In some embodiments, the forecast models may employ techniques such as gradient-boosted regression trees, recurrent neural networks, or seasonal autoregressive models. Forecast outputs may be serialized and stored alongside graph data, enabling scenario-based analyses within the analytics service.

The topological graph system 120 may coordinate these various services through a message bus or event-driven architecture. Inter-service communication may occur using asynchronous message queues (e.g., Kafka® topics or RabbitMQ® exchanges) and represent data streams such as “new resource ingested,” “graph updated,” or “switch state changed.” Each microservice may subscribe to the relevant topics and trigger internal updates or computations upon receipt.

In operation, a typical workflow may proceed as follows: incoming data from GIS and CIS systems may be ingested, canonicalized, and stored; the connectivity builder may reconstruct feeder graphs and merge subgraphs as necessary; updated graphs may be written to the datastore and broadcast to downstream services; the analytics and powerflow engines may consume those updates to recompute metrics or simulations; and the control and forecast services may act upon those results to maintain optimal grid performance.

In some embodiments, a graph versioning system may be employed to maintain historical snapshots of the network topology. Each modification to the graph, such as the addition of a resource, the merging of subgraphs, or a change in switch state, may create a new version identifier in the database. This feature may allow time-travel queries and support audit trails for regulatory compliance.

To ensure reliability and data integrity, the system may employ distributed consensus algorithms such as Raft or Paxos for coordination between compute nodes. It may also implement redundancy and replication across data centers to prevent data loss in the event of hardware or network failures. Security of the data pipeline may be maintained through mutual TLS authentication, role-based access control, and encryption at rest using standards such as AES-256.

From a user perspective, the system may expose an operator dashboard implemented as a web-based graphical interface. The dashboard may display real-time visualizations of the topological graph, overlaying telemetry data on each node and edge. Operators may issue commands directly through this interface, which may then be routed via the control service to the relevant field devices. The interface may also provide simulation and forecasting tools that allow operators to evaluate “what-if” scenarios using the current connectivity model.

Through the integration of ingestion, canonicalization, graph construction, analytics, control, and forecasting, the architecture shown in FIG. 1 may form a complete digital representation of a power distribution system. This representation may serve as a continuously updated “digital twin” of the grid, enabling advanced operational awareness, data-driven decision-making, and automated control based on accurate, dynamically maintained connectivity information.

### Graph Construction Process

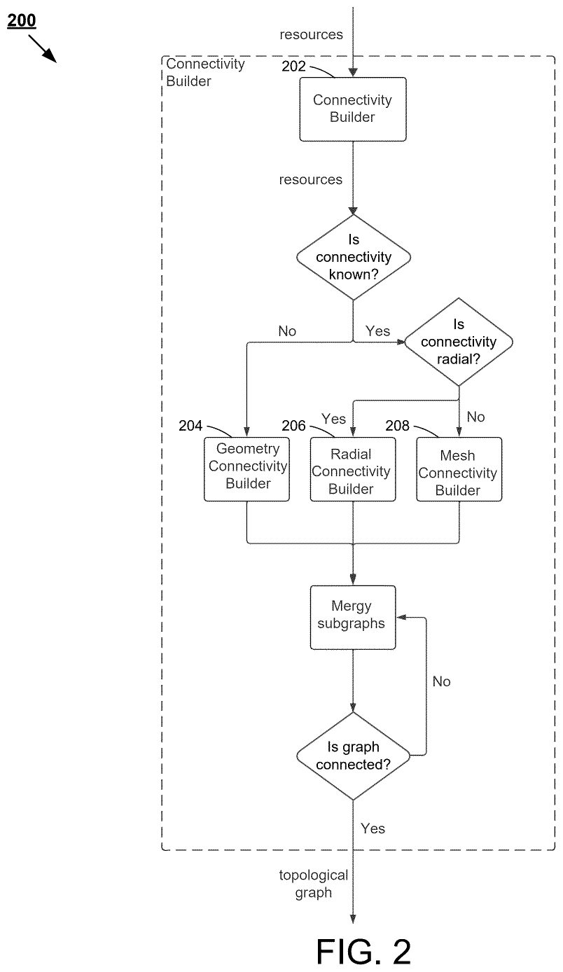

Referring now to FIG. 2, an embodiment of a computer-implemented process 200 for constructing a topological graph is shown. This process may be executed by one or more processors configured to transform canonicalized input data describing electricity grid components into a graph data structure representing the electrical connectivity of a feeder or substation.

In some embodiments, the process may be executed within a graph construction engine, which may be a software module running in the cloud-based environment described with respect to FIG. 1. The construction engine may operate as a set of microservices deployed across a distributed cluster of computing nodes, each node executing graph-building tasks in parallel on subsets of data. The architecture may employ container orchestration, such as Kubernetes® or Docker Swarm®, to ensure that multiple instances of the connectivity builder can process different feeders simultaneously without performance degradation.

Each execution of the process may begin when a job scheduler retrieves a batch of canonicalized resource data from the system datastore. The scheduler may assign each batch to a compute worker based on feeder identifiers, geographic proximity, or substation association. Each worker node may instantiate an in-memory graph object, referred to herein as a working graph, that is initialized with an empty set of nodes and edges.

The connectivity builder 202, as shown in FIG. 2, may first filter the input resource data to isolate all records belonging to a single feeder. Each record may be represented as a resource object, which may include attributes describing equipment type, geographic coordinates, electrical phase configuration, and known connectivity identifiers. The filtering operation may employ distributed query execution across the datastore, using map-reduce functions or parallel SQL execution to efficiently extract subsets of data corresponding to each feeder.

In one embodiment, the connectivity builder may next determine whether explicit connectivity information is available within the input data. This determination may be based on the presence of relationship fields such as “parent_id,” “upstream_bus,” or “downstream_bus” within the resource schema. If sufficient explicit connectivity information exists, the builder may invoke a radial connectivity module to construct the graph according to known parent-child relationships.

In the radial configuration, which is common for suburban and rural feeders, each resource representing a conductor or transformer may be linked to an upstream and downstream node. The builder may iterate through the resource list, creating nodes for each unique endpoint identifier and adding edges between those nodes according to the parent-child pairs defined in the data. Each edge may be labeled with the corresponding resource identifier and electrical parameters such as impedance and phase. The resulting structure may form a directed acyclic graph (DAG) representing the unidirectional nature of radial power flow from the substation toward customer endpoints.

In other embodiments, where the grid exhibits a more complex topology with loops or inter-ties between feeders, the builder may invoke a mesh connectivity module 208. This module may be configured to handle bidirectional and multi-source configurations. It may rely on attributes such as “bus_id,” “upline_id,” and “downline_id” to determine the interconnections among resources. The mesh connectivity module may construct an undirected graph that allows representation of redundant or reconfigurable paths between substations and loads. Each node may include metadata indicating whether it represents a source node (such as a substation bus), an intermediate connection (such as a switch or regulator), or a terminal node (such as a meter or photovoltaic inverter).

When neither radial nor mesh connectivity information is available, the process may invoke a geometry connectivity builder 204, which may infer connections from spatial proximity and orientation data. This module may access the geographic coordinates stored in each resource and perform a nearest-neighbor search to identify candidate connections. In some embodiments, the geometry builder may implement spatial indexing structures such as R-trees or k-d trees to accelerate proximity queries over large datasets. The builder may calculate the Euclidean or geodesic distance between pairs of resources and connect those whose separation distance falls within a configurable tolerance threshold, typically expressed in meters.

The geometry connectivity builder may also consider the orientation of conductor segments and the phase configuration when determining likely connections. For example, if two conductors terminate within two meters of each other and share at least one matching phase (e.g., phase A), they may be connected in the inferred topological graph. Conversely, if phase configurations differ completely or distances exceed the threshold, the resources may remain unconnected. This step may result in one or more disjoint subgraphs, each representing a portion of the feeder where connectivity could be inferred from spatial data.

In some embodiments, the geometry builder may perform iterative refinement using a probabilistic connection model. This model may assign a confidence score to each potential connection based on distance, phase match, conductor type, and directionality. Edges with confidence values above a configurable threshold may be added to the graph, while those below the threshold may be flagged for review. These operations may be executed in parallel using GPU acceleration or distributed matrix computation libraries, enabling scalability to datasets containing millions of resources.

Once the initial graph has been generated, the connectivity builder may perform a graph validation phase to ensure electrical consistency. The validation may check for orphan nodes (nodes with no connections), unreferenced edges, and cyclical dependencies that violate known feeder constraints. It may also verify that voltage levels decrease monotonically from source to load within a radial configuration, signaling correct directional assignment of edges. If validation errors are detected, the builder may flag the affected resources for review and may attempt to automatically repair connectivity using heuristic rules or historical topology data.

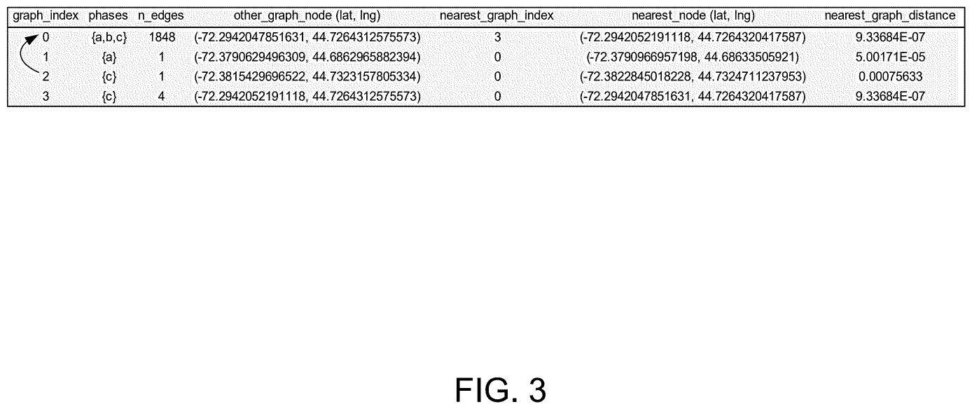

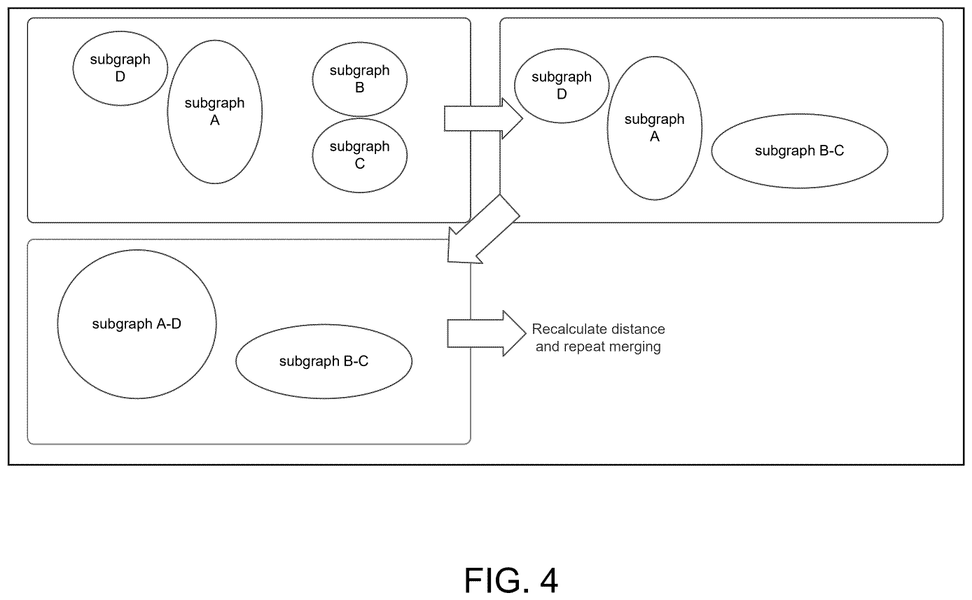

The resulting graph may then be analyzed to determine whether it is fully connected. If multiple disconnected subgraphs exist, the process may proceed to the subgraph merging algorithm, as described in connection with FIGS. 3-4. The connectivity builder may invoke a merging module that computes pairwise distances between subgraphs and merges those within allowable thresholds, iterating until a single unified graph is obtained.

Throughout this construction process, all intermediate and final graph data structures may be serialized and stored in a graph versioning repository. This repository may maintain metadata including timestamps, data source identifiers, and process logs. Each graph version may be indexed by feeder and substation identifiers, allowing downstream analytical services to query historical configurations or compare topological differences over time.

In some embodiments, the entire process depicted in FIG. 2 may be orchestrated using a workflow management engine such as Apache® Airflow, Prefect, or Argo® Workflows. Each step in the pipeline, from data ingestion to validation and merging, may be represented as a task node within the workflow. Dependencies among tasks may be explicitly defined, ensuring that graph validation occurs only after successful completion of construction. Workflow logs may capture execution metadata and error conditions for audit and debugging purposes.

In some embodiments, the process 200 may include numerous optimization mechanisms to improve computational performance. For example, intermediate graph objects may be cached in distributed memory systems such as Redis® or Memcached® to avoid re-computation during iterative merging. Edge construction and validation operations may be vectorized using libraries such as NumPy or cuDF, allowing simultaneous processing of thousands of edge relationships. For large networks, the connectivity builder may partition the graph spatially or electrically into smaller zones and process them concurrently across compute nodes, later merging the zones into a final feeder-level graph.

In some embodiments, the graph construction process may also incorporate data provenance tracking to maintain full traceability of how each connection was derived. For instance, the system may annotate each edge with a provenance tag indicating whether the connection was directly observed from utility data, inferred from geometry, or estimated from historical patterns. This information may later be used by analytics modules to assess the reliability of simulation results or by operators to prioritize field verification of uncertain connections.

The fully constructed topological graph produced by the process shown in FIG. 2 may then be stored within the system datastore described earlier with reference to FIG. 1, where it may be made accessible to downstream analytical, forecasting, and control services. The resulting graph may provide a mathematically consistent and computationally efficient representation of the distribution feeder, capable of supporting both steady-state and dynamic analyses.

### Subgraph Merging Algorithm

Referring now to FIGS. 3 and 4, embodiments of a computer-implemented subgraph merging process are shown. These figures illustrate how the system may merge partially connected subgraphs into a single unified topological graph representing an entire feeder or network. The subgraph merging algorithm may be an important stage of the overall graph construction pipeline, ensuring that the resulting connectivity model is continuous, electrically consistent, and computationally valid for analytical operations such as power flow or fault simulation.

In some embodiments, the subgraph merging algorithm may be executed automatically following the initial graph construction process described with respect to FIG. 2. The connectivity builder may first analyze the graph output to determine whether it contains multiple disconnected subgraphs. This determination may be made using a graph traversal or connectivity check function implemented within a graph-processing library such as NetworkX, igraph, or a distributed graph computation framework such as Apache Spark GraphX or deep graph library (DGL). The system may assign a unique identifier to each disconnected component, storing it in memory as a distinct subgraph object with associated metadata, including the number of nodes, number of edges, and phase composition.

As depicted schematically in FIG. 3, each subgraph may be characterized by an index (e.g., graph_index), a list of nodes and their corresponding phase sets, and a set of candidate nearest neighbors in other subgraphs. The merging algorithm may proceed by computing pairwise proximity metrics between subgraphs, determining which subgraphs should be merged and at what connection points.

In one embodiment, for each subgraph s_{gi}, the system may first identify all other subgraphs s_{gi} that share at least one electrical phase. To accomplish this, each node within a subgraph may maintain a bitwise representation of its phase configuration, encoded as a 3-bit integer corresponding to phases A, B, and C. The intersection of these bitwise representations may be computed rapidly using bitwise AND operations to determine whether any phases overlap. Only those subgraph pairs with non-zero phase intersections may be considered eligible for merging.

After identifying compatible subgraph pairs, the system may compute the shortest Euclidean or geodesic distance between nodes in the candidate subgraphs that share common phases. For large-scale networks, this operation may be accelerated using spatial indexing structures such as R-trees or ball trees. The coordinates of each node may be stored in an in-memory spatial index that supports fast nearest-neighbor queries, allowing the algorithm to find the closest compatible node pairs between subgraphs efficiently.

Each node pair may be associated with a calculated distance dᵢⱼ, phase compatibility score pᵢⱼ, and optional electrical plausibility metric derived from equipment attributes. For instance, the plausibility metric may penalize candidate connections that would imply unrealistic conductor lengths or voltage mismatches. These parameters may be combined into a composite cost function, expressed as:

Cᵢⱼ=αdᵢⱼ+β(1−pᵢⱼ)₊γfiⱼ

where α, β, and γ are weighting coefficients, and fᵢⱼ represents additional penalty terms based on impedance or device compatibility. The algorithm may minimize this cost function to identify the most probable connections between subgraphs.

In some embodiments, the merging algorithm may employ a greedy iterative approach. The system may begin with the pair of subgraphs exhibiting the lowest minimum Cᵢⱼ value and connect them by inserting a virtual edge between the corresponding nearest nodes. This virtual edge may initially be annotated as an inferred connection, pending validation. The smaller of the two merged subgraphs, defined by the one with fewer edges, may then be merged into the larger subgraph, and the overall list of subgraphs may be updated.

As depicted conceptually in FIG. 4, this process may continue iteratively, with each successive iteration recalculating nearest-node distances among the remaining unmerged subgraphs. The algorithm may terminate when a single connected subgraph remains or when the minimum distance between any remaining subgraphs exceeds a predefined threshold, which may be based on typical conductor segment lengths or field survey accuracy.

The merging operation itself may be implemented as an atomic database transaction to ensure data consistency. In some embodiments, each merge may create a transaction log entry recording the identifiers of the merged subgraphs, the nodes connected, and the rationale or cost metric for the merge. This transaction may be written to a graph versioning repository, enabling auditability and rollback if later analysis determines that an incorrect connection was inferred.

To ensure electrical correctness, the merged graph may be validated after each iteration using a power flow feasibility check. This check may simulate a simplified load flow across the merged nodes to verify that voltage drops and current flows are physically plausible. If the feasibility test fails (e.g., a connection between nodes at incompatible voltage levels), the system may automatically revert the merge transaction and mark the connection as invalid. This ensures that merely physically consistent merges are retained.

In some embodiments, the merging algorithm may leverage machine learning models trained on historical grid data to guide connection inference. The model may receive as input the distance between subgraphs, phase compatibility, equipment types, and geographic features, and may output a probability score indicating the likelihood that the subgraphs should be connected. The algorithm may use this probability to prioritize candidate merges and adjust thresholds dynamically. These models may be trained using supervised learning techniques on datasets containing verified connectivity information from previously validated feeders.

To handle very large distribution systems with tens of thousands of subgraphs, the merging process may be executed in parallel across compute nodes. Each node may handle a subset of subgraph pairs, computing their distance metrics and cost functions independently. A master coordination process may collect the results, determine the global minimum-cost merges, and distribute merge operations back to the workers. This parallelized approach may reduce the overall computational complexity from O(n²) to approximately O(nlog(n)) for typical datasets.

In some embodiments, the merging algorithm may include error propagation tracking. Each inferred edge may carry an uncertainty score based on the accuracy of input data and the confidence of the merge. As new telemetry or field data become available, the system may re-evaluate previously inferred connections, adjusting their confidence or replacing them with verified links. This self-correcting mechanism may allow the graph to converge toward a fully validated representation over time.

The data structures used to represent subgraphs and merges may be implemented in a high-performance memory format. Each subgraph may be stored as an adjacency list encoded in compressed sparse row (CSR) format, which allows efficient computation of node distances and traversal operations. During merging, adjacency lists may be concatenated and reindexed, updating node identifiers as necessary. To avoid data races in distributed environments, node identifiers may include globally unique 128-bit keys generated using hash functions such as SHA-1 or UUIDv5 based on resource metadata.

In one embodiment, the merging process may also include an optional visual validation subsystem. When low-confidence merges occur, the system may flag them for review and generate visual overlays combining GIS maps and the inferred connections. Field engineers or operators may use this interface to confirm or reject candidate connections. The decisions from such reviews may be fed back into the system's machine learning models to improve future merge predictions.

Once all subgraphs have been merged and validated, the resulting unified graph may represent a complete electrical topology of the feeder. The algorithm may then mark the final graph as “fully connected” and assign it a version identifier in the system datastore. The merged graph may be stored in both serialized and indexed formats: a binary graph object optimized for computational access and a human-readable JSON or YAML representation suitable for API queries and visualization.

In some embodiments, the merging algorithm may continue to operate incrementally as new data arrive. Rather than rebuilding the graph from scratch, the system may perform incremental graph maintenance, merging or splitting subgraphs as resources are added, removed, or updated. Incremental operations may be triggered by events in the ingestion pipeline, such as the addition of a new conductor or modification of a switch state. This allows the topological model to remain continuously synchronized with real-world grid configurations.

Overall, the subgraph merging algorithm described with reference to FIGS. 3 and 4 provides a robust and computationally efficient means of resolving incomplete connectivity data into a single, coherent network model. By combining geometric, electrical, and statistical reasoning within a distributed computing framework, the system may automatically reconcile fragmented or inconsistent datasets into a comprehensive topological graph that accurately represents the electrical connectivity of the electricity grid.

### Example Geometrical Graph

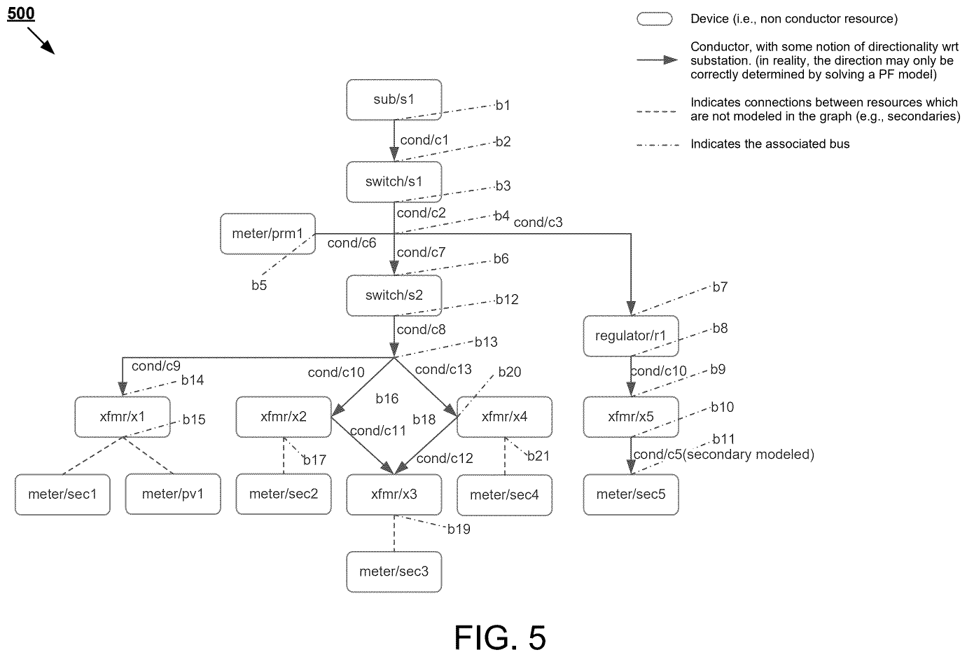

Referring now to FIG. 5, an embodiment of a geometrical graph 500 for a representative distribution feeder is illustrated. The geometrical graph may constitute an intermediate data structure generated by the connectivity-builder system described previously with reference to FIGS. 1-2, and may serve primarily to establish spatial relationships among electrical resources before the formation of the full electrical topology.

In the illustrated embodiment, the feeder may emanate from a substation node labeled sub/s1 and may include multiple conductors, switches, regulators, transformers, and meters distributed along its length. Each of these physical elements may be represented as a resource object stored in a canonicalized database record as described earlier. The geometrical graph may be assembled by retrieving the geographic coordinates of each resource, e.g., specified in latitude, longitude, and elevation, and plotting them as nodes or line segments within a digital coordinate space.

The coordinate data for each resource may be obtained from a GIS and may be normalized into a common coordinate reference system, such as EPSG:4326 (WGS-84) or a local state plane projection. The transformation may be performed automatically by a coordinate-normalization module, which may apply affine or geodesic transformations to align disparate data sources. Each transformed coordinate may then be stored in the graph geometry table of the system datastore, accompanied by a spatial index entry created using an R-tree or Hilbert-curve key to accelerate spatial searches.

In some embodiments, the geometrical graph 500 may be rendered dynamically by a visualization engine operating within an operator dashboard. The visualization engine may employ WebGL or similar graphics acceleration to display the feeder layout on a geographic base map. Each resource may be depicted by an icon corresponding to its type, switches, transformers, meters, and conductors, and may be color-coded according to operational status or voltage class. The visualization engine may subscribe to real-time telemetry topics from the message bus described with respect to FIG. 1, allowing the geometric representation to update interactively as new data arrive.

At the computational level, the geometrical graph may be represented internally as a directed graph object whose nodes correspond to discrete geographic points and whose edges correspond to line geometries describing conductor segments or other physical links. Each edge may contain polyline geometry data encoded using GeoJSON, well-known text (WKT), or binary geospatial formats such as FlatGeobuf. To reduce data transfer size, the geometries may be compressed using delta-encoding or run-length encoding prior to storage.

In some embodiments, each node in the geometrical graph may be associated with one or more attribute dictionaries containing electrical, physical, and operational metadata. Example attributes may include conductor material composition, wire gauge, installation date, phasing, and current-carrying capacity. These attributes may be stored in a document-oriented structure that can be queried by downstream modules to inform topological inference or analytics.

Because the geometrical graph represents spatial adjacency rather than electrical connectivity, the system may incorporate algorithms to ensure that spatial proximity does not result in erroneous electrical connections. For example, where two conductors cross in different physical layers (such as overhead and underground), the geometry builder may reference elevation or layer metadata to determine that no electrical connection exists. This determination may rely on additional datasets such as as-built design layers or LiDAR-derived elevation models.

To compute geometric relationships efficiently, the system may utilize spatial computation libraries such as GEOS®, PostGIS, or Shapely. During graph creation, the geometry builder may invoke functions such as ST_Intersects, ST_DWithin, or ST_Touches to detect whether conductors or devices lie within configurable proximity thresholds. In one embodiment, the system may compute a connectivity-candidate matrix, an N×N matrix representing pairwise distances between resources. This matrix may be stored temporarily in distributed memory and may be filtered to retain only those pairs of resources whose separation distances fall below a configurable threshold, such as 5 meters.

In some embodiments, the geometry builder may execute a directionality-assignment routine. This routine may analyze conductor geometries to infer likely flow direction from the substation outward toward customer endpoints. For example, each conductor's line vector may be compared with the location of the nearest substation node, and the direction may be assigned accordingly. While purely geometric in nature, this directional information may serve as a prior for the later topological graph construction stage.

The geometrical graph 500 may also include secondary indicators such as dashed lines representing unmodeled connections (e.g., secondary conductors or service drops) and annotations indicating bus identifiers or device groupings. These annotations may be stored as lightweight overlay layers within the visualization subsystem, enabling selective display without altering the underlying data model.

From a computational standpoint, the geometrical graph may reside in memory as a multi-layer graph structure. The base layer may include the primary geometric nodes and edges, while additional layers may store derived features such as phase attributes, asset ownership, or feeder section boundaries. This multilayer design may allow algorithms to perform operations selectively on one or more layers, such as phase-specific connectivity analysis, without recomputing the entire graph.

In some embodiments, the geometrical graph 500 may support spatial analytics prior to topological transformation. For instance, the system may calculate the total conductor length within a given feeder, determine the density of distributed energy resources along a corridor, or identify clusters of assets requiring inspection. These computations may use map-reduce patterns or GPU-accelerated spatial joins, allowing near-real-time performance even on large utility datasets containing hundreds of thousands of geometries.

Once the geometrical graph has been established and verified, it may serve as an input to the connectivity builder described earlier. The geometrical relationships encoded in this graph may be used to infer missing electrical connections through the proximity-based and phase-matching algorithms discussed with reference to FIG. 2. The transition from the geometrical to the topological representation may involve collapsing geometric coordinates into logical bus nodes and assigning conductors and devices as edges between those buses.

In some embodiments, the geometrical graph may also be used independently for operational and visualization purposes. For example, utility planners may overlay outage data or vegetation-management zones onto the geometrical representation to support field-crew dispatch or maintenance scheduling. Because each geometric entity is linked by unique identifiers to the corresponding canonical resource records, the geometrical graph may serve as a bridge between geographic and electrical domains, ensuring that updates made in one context propagate accurately to the other.

Thus, the geometrical graph 500 illustrated in FIG. 5 provides a spatially explicit, data-driven representation of the distribution feeder that underlies the more abstract topological model. By maintaining high-resolution coordinate data, accurate spatial indexing, and real-time visualization capabilities, the geometrical graph stage of the system may provide the foundation upon which complete, validated electrical connectivity models are constructed.

### Topological Graph Representation

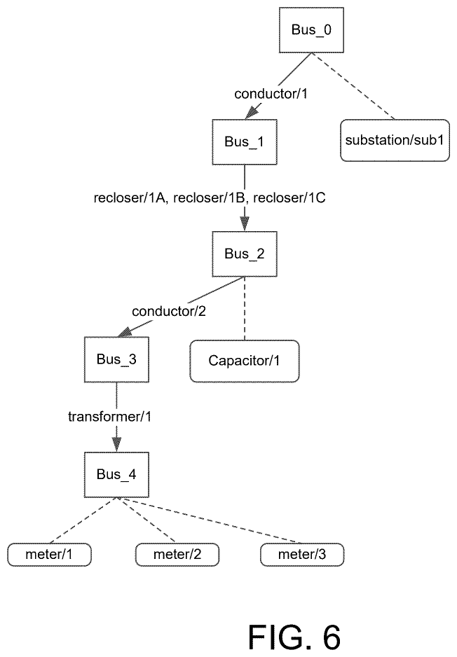

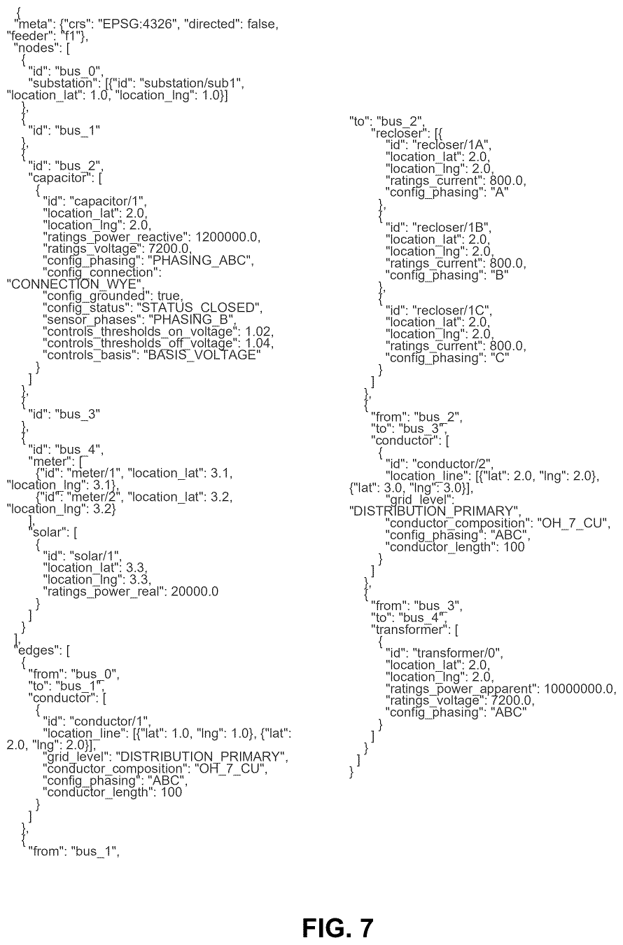

Referring now to FIGS. 6 and 7, the disclosure provides a topological representation of the electricity grid that captures electrical connectivity independently of geographic layout. The topological graph may be a machine-readable and computationally optimized abstraction of the physical system. It may encode, in a canonical and extensible form, the relationships among all resources that constitute the distribution feeder or substation network, including but not limited to conductors, switches, transformers, meters, regulators, capacitors, photovoltaic inverters, and energy storage units.

In one embodiment, the topological graph may be generated by the connectivity builder described earlier with reference to FIG. 2, using either explicit connectivity data or inferred relationships derived from geometrical proximity and phasing analysis. The resulting data structure may be instantiated in memory as an object-oriented model and persisted to a graph database for query and computation. The database may be implemented using technologies such as Neo4j®, JanusGraph, Amazon® Neptune, or an open-source equivalent that supports atomicity, consistency, isolation, and durability (ACID) transactions, schema extensibility, and graph query languages such as Gremlin, Cypher, or SPARQL.

Each node within the topological graph may correspond to an electrically distinct bus or node, and each edge may represent one or more resources that electrically connect two buses. As shown schematically in FIG. 6, an exemplary feeder may include five buses labeled bus_0 through bus_4. The substation element may be associated with bus_0, while other resources, such as conductors, switches, and transformers, may form edges connecting the remaining buses. Certain resources such as meters or capacitors may attach directly to a bus, representing a parallel connection to ground or a local reference node rather than an inter-bus edge.

The graph data model may be defined by a schema containing node and edge entity types, each with associated attributes. Each node may include identifiers, associated resources, and metadata describing voltage levels, connectivity roles, and geographic coordinates. For example, a node record may include the following fields: node_id (unique identifier, possibly a UUIDv4 or 128-bit hash derived from canonical resource IDs); bus_voltage_level (e.g., 12.47 kV, 7.2 kV, 480 V); bus_phasing (e.g., ABC, ABN, single-phase A); associated_resources (e.g., list of resource references such as substation, capacitor, meter, or PV device); spatial_reference (e.g., optional centroid coordinates for mapping and visualization); and metadata (including creation timestamp, data provenance, and versioning information).

Edges may represent physical connections between buses and may also contain multiple nested resources, each describing a segment of conductor or an intermediate device. Each edge record may include attributes such as: edge_id (unique identifier); from_bus and to_bus (references to node identifiers); resource_list (e.g., one or more resource objects representing the physical equipment forming the connection); electrical_parameters (e.g., impedance, admittance, length, phase configuration, conductor material, and ampacity); and connection_state (e.g., open, closed, faulted, or de-energized).

In some embodiments, edges may be directed or undirected depending on the network configuration. For radial networks, edges may be directed from the source toward the load; for meshed networks, the graph may be undirected to reflect bidirectional flow capability. The database schema may therefore support a “directed” attribute for each edge, dynamically adjustable based on system configuration or switch states.

As illustrated in FIG. 7, the topological graph may be serialized into a structured payload format for storage and exchange. In one embodiment, this payload may be represented as a JSON document, comprising a “nodes” array and an “edges” array. Each node object may include the associated resources (e.g., substation, capacitor, or meter) as nested objects, complete with location and configuration data. Each edge object may include conductor, recloser, and transformer elements as nested arrays, each containing electrical and geometric attributes.

For computational efficiency, the serialized graph may also be stored in a binary interchange format such as Apache® Avro, Protocol Buffers, or MessagePack. This enables fast deserialization during analytical queries or power-flow computations. When persisted to long-term storage, graphs may be compressed using algorithms such as LZ4 or Zstandard, reducing memory footprint while maintaining random-access decompression capability.

In some embodiments, the topological graph may include a hierarchical indexing structure that enables efficient traversal and computation. The index may group nodes by feeder, substation, or geographic zone, using a hash partitioning scheme. Each partition may be stored as a shard in the graph database cluster, enabling parallel query execution. Cross-partition edges may be maintained through lightweight reference pointers or foreign keys that ensure referential integrity across shards.

The graph computation engine may support traversal operations such as depth-first search (DFS), breadth-first search (BFS), Dijkstra's shortest path, and minimum-spanning-tree algorithms. These operations may be implemented using distributed processing libraries and may operate on in-memory graph representations to achieve high performance. For instance, when computing the shortest electrical distance between two buses, the system may weight each edge by its impedance magnitude rather than geometric length, thereby reflecting electrical (not spatial) distance.

The topological validation module may continuously verify that all edges and nodes comply with physical and electrical rules. Validation checks may include phase continuity (ensuring no connections between mismatched phases), voltage-level consistency, and loop detection for feeders expected to operate radially. In one embodiment, the validation module may generate an exception report listing anomalies such as open-ended conductors, unconnected resources, or conflicting phase information. These exceptions may trigger automated corrective routines or human review.

To enable incremental updates, the system may maintain a graph mutation interface. When a resource is added, removed, or modified, the mutation service may retrieve the affected subgraph, apply changes in-memory, and commit an updated version back to the database. Version control may be implemented using copy-on-write semantics, where each update generates a new immutable graph snapshot. Snapshots may be stored with globally unique version identifiers and timestamps, allowing rollbacks and time-series analysis of network evolution.

In some embodiments, the topological graph may integrate seamlessly with time-series telemetry data. Each node or edge may maintain foreign key references to measurement streams in a time-series database. For example, a capacitor node may link to telemetry values representing reactive power output, while a conductor edge may link to line current sensors. These references may enable synchronized queries that combine topological structure with temporal data, facilitating dynamic analytics and predictive maintenance applications.

To support large-scale computation, the graph data structure may be mapped into distributed memory using frameworks such as Apache® Arrow or Parquet. The system may store numerical parameters (such as impedance matrices or connectivity matrices) in columnar format, enabling vectorized computation for power flow and optimization algorithms. The columnar storage design may reduce data-access latency and improve cache utilization across compute nodes.

In one embodiment, the topological graph may also serve as the core data structure for a digital twin of the power distribution network. The digital twin may run continuous simulations of grid behavior, ingesting telemetry data in real time and updating node and edge attributes accordingly. For example, if a switch state changes, the system may update the “connection_state” field of the corresponding edge, re-solve the network equations, and broadcast the new voltage and current values to operator dashboards within milliseconds.

The system may further implement security and consistency mechanisms to protect the integrity of the topological graph. Access to the graph database may be controlled through role-based access control (RBAC) and multi-factor authentication. All read and write operations may be logged with cryptographic signatures, ensuring non-repudiation. Periodic integrity checksums may be computed and stored alongside the graph data, allowing verification of database consistency across distributed replicas.

In some embodiments, the topological graph may be extended to include logical overlays representing derived or virtual nodes. These may include aggregation nodes representing load centers, sectionalizing boundaries, or feeder summaries. Logical overlays may be computed dynamically using aggregation operators over the physical graph. For example, all nodes downstream of a specific switch may be aggregated into a virtual “load area” node with cumulative real and reactive power attributes.

The API for the topological graph may expose RESTful and gRPC endpoints that allow external systems to query, modify, and analyze the graph. Query parameters may include but not limited to feeder ID, geographic bounds, voltage class, or resource type. The API may return data in standard formats such as JSON-LD or GraphML for compatibility with third-party analytical tools. In some embodiments, the API may also support WebSocket® streams for real-time subscription to topology updates.

As illustrated in FIG. 7, the topological graph may serve as a unifying data model for analytics, forecasting, and control operations. The payload format demonstrated in this figure provides a canonical reference for all downstream computational services. For example, the analytics service may traverse the graph to compute energy losses or fault propagation paths; the powerflow service may translate the graph into nodal admittance matrices for numerical solution; and the control service may query edges to determine which switches or regulators must be actuated to achieve desired operating objectives.

In operation, this unified topological representation may allow utilities to perform complex analyses and control tasks that were previously impractical due to fragmented or incomplete data. The graph may support millisecond-level query response times for critical operations such as isolation detection, topology validation, and DER coordination. Moreover, because the graph model is fully versioned and auditable, it may provide a verifiable digital record of network connectivity across time, facilitating regulatory compliance and forensic analysis after system events.

In summary, the topological graph described with reference to FIGS. 6 and 7 may provide a robust, extensible, and computationally efficient representation of an electrical distribution system. It may integrate spatial, electrical, and operational data into a single structure capable of supporting real-time analytics, control, and forecasting. Through the use of distributed computing, graph databases, and versioned storage, the disclosed system ensures that the topological model remains accurate, scalable, and continuously synchronized with field conditions.

### Switch-State Topology Handling

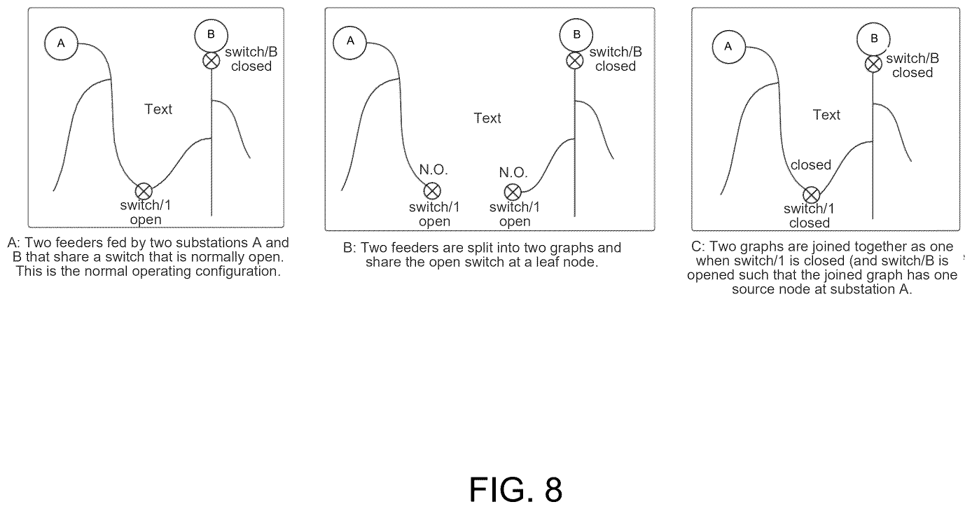

Referring now to FIG. 8, embodiments of the system for handling switch states and dynamic topology changes are shown. This aspect of the disclosure may enable the topological graph to represent, in real time, the changing electrical connectivity of a distribution network as switches, circuit breakers, and reclosers open or close in the field. Such state changes may alter the logical structure of the graph, splitting or merging feeders, rerouting current paths, and affecting power-flow and control calculations.

In one embodiment, the switch-state handling process may be implemented by a dynamic topology manager, a specialized software component that operates in conjunction with the connectivity builder and graph database described with respect to FIGS. 1-7. The topology manager may continuously monitor telemetry streams and command logs associated with all switching devices represented in the system. These telemetry streams may be received from field devices via secure protocols such as DNP3, IEC 61850 GOOSE, or MQTT, and may include status indicators, timestamps, and source identifiers. Each telemetry record may be parsed by an ingestion module, normalized into canonical form, and appended to a message bus topic such as “switch_state_updates.”

A set of microservices may subscribe to the switch-state topics and may update the topological graph synchronously upon receiving new events. Each update message may contain the device identifier, its new state (e.g., open, closed, faulted, or intermediate), and a timestamp. The topology manager may retrieve the corresponding edge in the graph database using the device identifier as a key and may modify the connection_state attribute of that edge accordingly.

If a switch transitions from closed to open, the system may execute a graph-partitioning routine to determine whether the network has separated into multiple disconnected components. This routine may use a breadth-first traversal starting from the source node to identify all reachable buses; any nodes not visited during the traversal may be assigned to a new disconnected subgraph. Each resulting subgraph may then be stored as an independent feeder object within the database, with metadata indicating its origin and timestamp of separation. Conversely, when a switch transitions from open to closed, the topology manager may merge the affected subgraphs by connecting their respective buses, following the same merging logic discussed previously with respect to FIGS. 3-4.

In some embodiments, the topology manager may maintain an in-memory incremental update cache. Rather than recomputing the entire graph on each switch event, the manager may apply localized modifications. Each affected edge may be updated in constant time, and only the subgraphs directly connected to that edge may be recalculated. The cache may store adjacency lists and subgraph metadata to support rapid re-computation, reducing average topology-update latency to less than one second even in large-scale networks.

The topology manager may further maintain a temporal version chain of the graph. Each switch event may create a new graph version that references its parent version and records the delta, the minimal set of changes required to update the prior version. These deltas may be encoded as compact binary patches, containing only the identifiers and state transitions of affected edges. This design may allow users or automated systems to reconstruct historical network topologies for any given time, enabling time-series analysis of switching operations, fault isolation sequences, or restoration procedures.

To ensure consistency across distributed environments, the system may implement an event-driven consensus mechanism. When multiple switch-state updates occur concurrently on different compute nodes, a coordination service such as etcd, ZooKeeper®, or a consensus algorithm implementing Raft may determine the authoritative update order. Each event may carry a monotonically increasing logical timestamp, and conflicts may be resolved deterministically based on predefined priorities (e.g., manually confirmed control-room commands overriding automated telemetry).

The dynamic topology updates may be propagated to other microservices through an internal publish-subscribe bus. Upon completion of a graph mutation, the topology manager may publish an event such as “graph_updated(feeder_id, version_id).” Downstream services, including analytics, powerflow, and control modules, may subscribe to these events and automatically re-load the updated topology. This event-driven design may ensure that all computational services operate on the most current representation of the network.

In some embodiments, the system may perform predictive pre-computation of potential topology states. For commonly executed switching operations, such as tie-switch closures for load transfer, the topology manager may maintain pre-compiled versions of the graph representing each possible configuration. When a switch state changes, the manager may activate the appropriate pre-computed graph instantaneously, eliminating the need for on-the-fly re-computation. Such pre-computation may be particularly beneficial for time-critical operations such as fault isolation and service restoration.

To prevent erroneous state transitions, the system may include a validation and authorization layer. Before applying a switch update to the graph, the topology manager may validate the operation against operational constraints stored in a policy database. These constraints may include maximum allowable feeder load, directional flow restrictions, or protection-device coordination requirements. If a proposed switch closure would result in a violation, e.g., back-feeding a de-energized line, the operation may be automatically rejected or flagged for human review.

The topology manager may also interface with the powerflow service to ensure electrical consistency following state changes. After each topology update, the system may trigger a limited-scope powerflow calculation restricted to the affected region of the network. The solver may verify that voltage magnitudes and line currents remain within acceptable limits. If violations are detected, the manager may revert the graph to the prior version and record the failed state change in an event log.

At the data-storage layer, switch-state events may be recorded in a time-series database linked to the corresponding edges in the topological graph. Each entry may include timestamps, device IDs, the resulting feeder identifiers, and metadata describing the initiating actor (e.g., automated control system, field technician, or protective relay). This historical dataset may enable analytical applications to reconstruct the sequence of switching operations that led to a particular grid configuration.

The visualization engine described earlier may provide a graphical interface for monitoring and controlling switch states. In some embodiments, when a switch event occurs, the dashboard may animate the change in topology, highlighting merged or separated feeders in different colors. Operators may view the real-time flow direction and power levels across the affected sections. The user interface may communicate with the topology manager through secure WebSocket® connections, ensuring that visualizations reflect the most current topology version.

From a computational standpoint, switch-state handling may involve concurrent updates to graph structures distributed across multiple memory partitions. To achieve atomicity, the topology manager may employ multi-version concurrency control (MVCC) techniques. Each graph shard may maintain versioned edge records, and updates may be applied transactionally. Queries executing during a topology change may continue to access consistent read-only snapshots of the prior version until the update transaction is committed. This mechanism may prevent race conditions and maintain deterministic query results even during high-frequency switching events.

In one embodiment, the system may also incorporate machine-learning-based prediction of switch behavior. The topology manager may analyze historical switching data to identify recurring operational patterns, such as diurnal load transfers or seasonal reconfigurations. Using this information, the manager may pre-emptively load alternate graph versions into memory or simulate their effects on voltage profiles and losses. These predictive capabilities may support advanced optimization functions such as proactive feeder reconfiguration for loss minimization or congestion relief.

The topology manager may further support resilience and recovery mechanisms. During large disturbances, such as storm-related outages, hundreds of switch events may occur in rapid succession. The system may employ distributed queues and rate-limiting controls to ensure orderly processing of events without overloading compute nodes. In the event of network partitioning or node failure, the consensus layer may redistribute unprocessed events to available nodes, guaranteeing eventual consistency across the system.

The dynamic topology representation may thus operate as a continuously evolving digital twin of the physical grid. Each change in field conditions, whether initiated by automated controls, operator actions, or fault conditions, may be mirrored in the graph model within seconds. Downstream services relying on the graph, such as DER dispatch algorithms or fault-location engines, may thereby maintain accurate situational awareness.

As shown in FIG. 8, parts A, B, and C illustrate representative scenarios demonstrating how switch states affect graph configuration. In parts A and B, two feeders are supplied by independent substations A and B and are separated by a normally open tie switch. In these configurations, the graph consists of two disconnected components. In part C, when the tie switch (switch/1) closes and another switch (switch/B) opens, the two feeders merge into a single graph with one active source node at substation A. The topology manager may automatically reassign node and edge identifiers, recompute feeder identifiers, and update all downstream analytical datasets to reflect this merged configuration.

Through the combination of event-driven architecture, distributed consensus, transactional graph updates, and real-time visualization, the system described with reference to FIG. 8 may provide a robust and scalable mechanism for representing the dynamic electrical topology of a power distribution network. By continuously synchronizing the digital graph model with field operations, the disclosed system may enable real-time analytics, adaptive control, and automated restoration strategies that rely on an accurate and current understanding of grid connectivity.

### Example Applications

The graph-based connectivity model disclosed herein may form the analytical and operational core of a broad range of applications used by electric utilities, grid operators, and planners. By combining canonicalized data ingestion, automated graph construction, dynamic topology management, and distributed computation, the system may deliver a continuously updated and computationally tractable digital twin of the distribution network. The following paragraphs describe exemplary implementations that illustrate how the disclosed system may be used to support daily operation, planning, forecasting, and control.

In one embodiment, the system may operate as a situational-awareness platform for distribution system operators. The topological graph maintained by the connectivity builder and topology manager may represent the current electrical state of every feeder, substation, and device. Real-time telemetry, received through the message bus described earlier, may continuously update node voltages, current flows, switch positions, and DER outputs. The analytics service may poll these data streams and execute a series of graph-traversal routines to compute derived quantities such as feeder loading, voltage imbalance, and loss factors. These computations may be performed every few seconds and may be visualized on an operator dashboard. Nodes and edges in the visualization may change color dynamically according to voltage magnitude or load percentage, allowing operators to identify emerging constraints at a glance.

In some embodiments, the analytics service may implement a real-time loss estimation algorithm. Using the impedance values stored in each edge of the topological graph, the system may calculate I²R losses by traversing the feeder tree from the source outward. This traversal may be parallelized across multiple compute threads using breadth-first search on the adjacency matrix. The results may be aggregated and presented as both instantaneous and cumulative energy-loss metrics, which may assist utilities in optimizing capacitor-bank dispatch or voltage-regulation schedules.

The disclosed system may also support fault detection and isolation. When a sudden voltage drop or current surge is detected in telemetry data, the analytics engine may localize the fault by propagating a signal backward along the graph edges from affected meters or sensors until it encounters a device capable of isolation, such as a fuse or recloser. The topology manager may then simulate potential switching actions by virtually opening or closing edges and computing the resulting connectivity using the same routines described with reference to FIG. 8. Once a feasible isolation configuration is identified, the control service may issue corresponding field commands via secure communication protocols. Because the topological model reflects actual phasing and impedance, the algorithm may identify isolation boundaries that minimize customer outages and maintain safe voltage levels throughout the remaining energized sections.

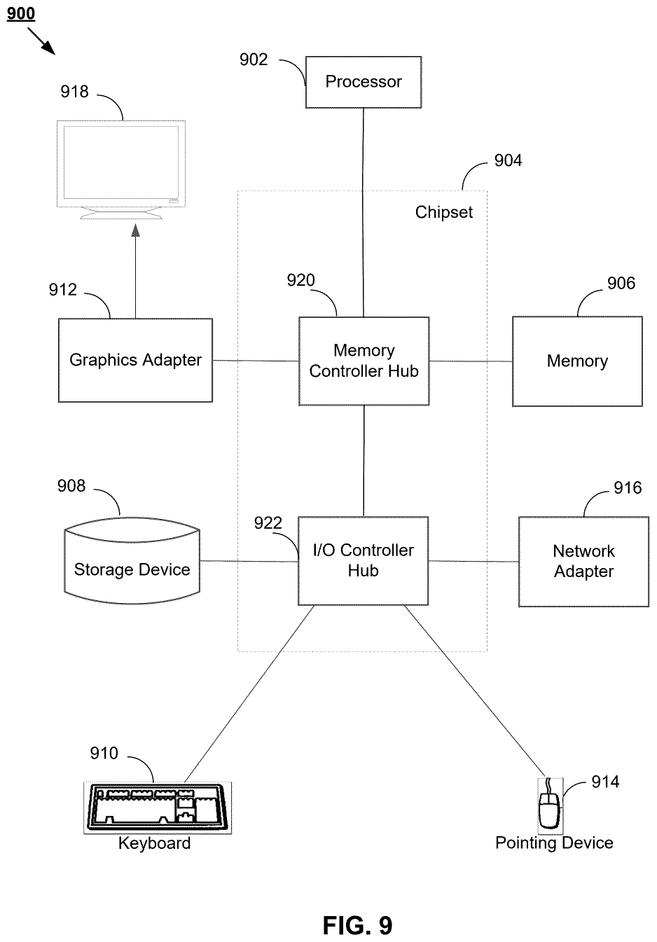

In another embodiment, the system may perform distribution-level power-flow optimization. The powerflow service may use the nodal admittance matrix derived from the graph to compute voltage and current magnitudes at every bus. The results of these computations may be combined with load and generation forecasts provided by the forecast service. Optimization routines implemented within the control service may then adjust controllable devices, such as on-load tap changers, capacitor banks, or inverter reactive-power setpoints, to minimize technical losses, flatten voltage profiles, or maintain phase balance. These control actions may be transmitted to field devices through the communication network described with reference to FIG. 9. Because the optimization relies on the same topological graph that underlies the analytics, all actions may be traceable to a validated model of the current grid configuration.

The graph model may further enable load forecasting and scenario analysis at multiple spatial and temporal scales. The forecast service may ingest historical time-series data from meters, DERs, and substation SCADA systems, which may be indexed by their associated node identifiers. Machine-learning models, such as long short-term memory (LSTM) networks or gradient-boosted decision trees, may be trained to predict future power and energy consumption at the node level. The predictions may then be propagated through the graph to estimate feeder-level or substation-level demand. These forecasts may be used to assess transformer loading, voltage compliance, or capacity adequacy under varying weather or electrification scenarios.

In some embodiments, the system may execute DER coordination and hosting-capacity analysis. Each distributed generator, storage system, or controllable load may be modeled as a resource connected to a specific node. The analytics service may simulate incremental DER injections by adjusting nodal power injections and resolving the powerflow equations. By iterating this process and monitoring voltage and thermal constraints on edges, the system may determine the maximum DER capacity that can be connected without violating limits. Results may be stored as node attributes within the graph, allowing planners to visualize available hosting capacity geographically.

The disclosed system may also provide a load-management and curtailment platform. During peak-load periods, the control service may identify network sections approaching thermal or voltage limits by analyzing edge currents in the graph. It may then compute curtailment strategies that selectively reduce loads or generation in specific areas. For instance, electric-vehicle charging stations modeled as resources may receive temporary power-reduction commands, or inverter-based solar resources may be instructed to absorb reactive power to relieve voltage rise. Each control command may be issued after verifying, through a rapid incremental powerflow computation, that the resulting configuration remains electrically stable.

In one operational mode, the system may perform real-time restoration planning following a fault or outage. Using the dynamic topology manager described with respect to FIG. 8, the system may simulate potential switching sequences to restore service to as many customers as possible while avoiding overloads. Each candidate sequence may be evaluated using fast graph-traversal algorithms and incremental powerflow solvers. Once an optimal sequence is determined, the control service may generate a step-by-step switching plan that can be executed automatically or under operator supervision. The plan may be logged in the event history, and the resulting topology version may be stored in the graph-version repository for post-event analysis.

Planners and engineers may employ the system for long-term planning and asset management. By leveraging the historical graph versions stored in the system datastore, the analytics service may reconstruct how the network topology has evolved over months or years. This temporal graph analysis may reveal trends such as load growth in specific regions, increasing interconnection of DERs, or frequent reconfiguration events in certain feeders. These insights may guide capital-investment decisions, transformer replacements, or protective-device coordination studies.

The graph-based model may also facilitate predictive maintenance. The analytics engine may correlate equipment-failure histories with graph-derived parameters such as electrical stress, number of switching cycles, or proximity to high-fault-current paths. Machine-learning algorithms may identify patterns indicative of impending failures, prompting pre-emptive inspections. Maintenance recommendations may be generated automatically and displayed on the operator dashboard, prioritized by the criticality of the affected node or edge within the overall network topology.

In some embodiments, the disclosed system may support regulatory compliance and reporting. The system may generate auditable records of all topology versions, switch operations, and control actions, each associated with timestamps and user identifiers. These records may be exported in standardized formats such as the common information model (CIM) for submission to regulatory bodies or integration with enterprise asset-management systems.

From an architectural perspective, the topological graph may serve as a data-exchange backbone between different utility applications. Planning, operations, outage management, and distributed-energy-resource management systems may all interface with the same graph database through APIs. Each system may retrieve or update portions of the graph within its operational domain while maintaining overall model consistency. The use of canonical resource schemas ensures interoperability across vendor platforms and simplifies data integration efforts.

The platform may also be extended to support cross-utility coordination. Neighboring utilities or microgrids may expose portions of their topological graphs through secure, federated interfaces. By exchanging summary connectivity data at boundary nodes, multiple operators may coordinate power transfers, share situational awareness, and jointly manage contingencies that span jurisdictional boundaries. Data privacy may be preserved through differential-privacy algorithms and encryption of sensitive node attributes.

In another embodiment, the system may enable training and simulation environments for operator education. The graph database may be cloned into a sandbox environment, and synthetic telemetry streams may be injected to emulate real-world conditions such as faults, DER fluctuations, or switching events. Trainees may interact with the simulation through the same operator dashboard used in live operations, observing how the network responds to their actions in real time. Because the simulation uses the same topological computation engine, it may accurately reproduce electrical dynamics under various scenarios.

In addition to operational uses, the graph-based system may support research and algorithm development. External researchers may query anonymized graph data via standardized APIs to develop new optimization techniques, fault-detection algorithms, or machine-learning models. The distributed computing environment described with reference to FIG. 9 may allow these computations to be executed in a secure, sandboxed environment using dedicated compute quotas.

Overall, the system described herein provides a unified computational framework that integrates grid modeling, real-time analytics, forecasting, and control into a single data architecture. By representing all components of the distribution network as nodes and edges in a continuously updated topological graph, the system may deliver an unprecedented level of accuracy, visibility, and automation. Whether used for day-to-day operation, emergency restoration, long-term planning, or policy compliance, the disclosed framework may fundamentally transform how electric distribution systems are monitored, analyzed, and managed.

### Computing Environment

Referring now to FIG. 9, an exemplary computing environment suitable for implementing the various systems and methods described herein is illustrated. The computing system 900 may include one or more processors 902, a memory controller hub 920, an input/output controller hub 922, a main memory 906, a storage subsystem 908, a graphics adapter 912, a display 918, and one or more input and network interfaces 910, 914, and 916. These components may be interconnected via system buses or high-speed interconnects such as PCI Express or NVLink, enabling rapid data exchange among subsystems.

In some embodiments, the processor 902 may be a multi-core central processing unit (CPU) or a heterogeneous combination of CPUs and graphics processing units (GPUs). The processor may include vector processing extensions and hardware acceleration units to support numerical computation workloads, such as linear algebra operations and graph traversal algorithms. The processor 902 may execute program code stored in memory 906 to perform tasks including but not limited to: ingesting data, constructing and merging graphs, executing power-flow simulations, and processing switch-state updates.

The main memory 906 may comprise high-speed volatile memory, such as DDR5 or HBM, configured to store active data structures including adjacency lists, graph matrices, and telemetry caches. In some embodiments, memory 906 may employ hierarchical caching, with L1-L3 caches at the processor level and shared L4 caches accessible to all processing cores. To accelerate large-scale graph analytics, portions of the topological graph may be memory-mapped directly into DRAM using techniques such as memory-mapped I/O or persistent memory (PMEM), reducing disk access latency.

The storage subsystem 908 may include one or more non-transitory computer-readable media, such as solid-state drives (SSD), magnetic disks, or network-attached storage (NAS) arrays. The subsystem may store persistent copies of resource data, graph versions, telemetry logs, and analytical results. In some embodiments, the storage may be organized into separate tiers: a hot-storage layer for frequently accessed graph data and a cold-storage layer for historical or archived versions. Data replication and sharding may be managed by a distributed file system such as Hadoop distributed file system (HDFS), Ceph, or Amazon® S3.

The input/output controller hub 922 may manage communication between memory, storage, and peripheral devices. It may implement direct memory access (DMA) channels to facilitate high-throughput data transfer between network adapters and memory without CPU intervention, improving the responsiveness of real-time telemetry ingestion pipelines.

The network adapter 916 may provide connectivity between the computing system 900 and other systems in the cloud or enterprise network. In some embodiments, the network interface may support multiple communication protocols, such as Ethernet, InfiniBand, or optical links, operating at speeds of 10 Gbps or higher. Network communication may be secured using TLS and authenticated using digital certificates issued by the platform's internal certificate authority.

In one embodiment, computing system 900 may function as a node in a distributed cluster supporting horizontal scaling. Each node may host one or more microservices, such as the connectivity builder, topology manager, analytics engine, or control service described in earlier sections. The nodes may communicate using a service mesh architecture, which may include sidecar proxies and service discovery mechanisms implemented via technologies such as Envoy®, Istio®, or Linkerd®. This architecture may provide dynamic load balancing, failure recovery, and observability across services, enabling high reliability and maintainability of the platform.

In some embodiments, the distributed system may employ container orchestration for deployment and scaling. Each software module may be packaged as a container image and deployed on a container orchestration platform such as Kubernetes®. Kubernetes® may automatically allocate compute resources, manage container lifecycles, and restart failed services. The orchestration layer may also handle rolling updates and blue-green deployments, ensuring continuous availability even during software upgrades.

To manage large-scale computation efficiently, the system may incorporate a distributed task scheduler such as Apache® Airflow, Prefect, or Ray. This scheduler may divide graph computation jobs into discrete tasks, distribute them among available compute nodes, and monitor execution progress. Each task may execute as an isolated job in a container, with resource limits and retry policies defined through configuration. The scheduler may support task dependencies, ensuring that graph validation, merging, and analytics are executed in the correct order.

In some embodiments, computing system 900 may employ GPU acceleration to speed up numerically intensive computations such as matrix operations in power-flow solvers or distance computations during subgraph merging. GPU kernels may be implemented using CUDA, OpenCL®, or Vulkan® compute frameworks, and may leverage unified memory models that allow CPU and GPU cores to share the same address space. The system may dynamically allocate workloads between CPU and GPU depending on the computational characteristics of each task, balancing throughput and latency.

The system may also integrate distributed in-memory data grids, such as Apache® Ignite or Hazelcast®, to share intermediate graph objects across nodes. These data grids may provide fast access to shared data while maintaining consistency through replication and partitioning mechanisms. For instance, an adjacency matrix computed on one node may be stored in the data grid and accessed by another node performing power-flow calculations.

The analytics and powerflow services described earlier may execute within this environment, utilizing the computational resources of the cluster. Each analytical module may be implemented as a stateless service that pulls data from the graph database or time-series store, executes its computation, and writes results to an output topic or table. For example, a load-forecasting module may retrieve node-level consumption data, apply machine-learning models using TensorFlow® or PyTorch®, and publish the predicted values back to the message bus for consumption by the control service.

In one embodiment, computing system 900 may further include an edge computing layer. This layer may include smaller embedded processors deployed closer to field devices, such as substation automation controllers or recloser relays. These edge nodes may execute lightweight versions of the graph computation algorithms to perform localized decision-making, such as sectionalizing a feeder after a fault. Edge nodes may synchronize periodically with the central cloud system via encrypted communication channels, uploading telemetry and receiving updated graph configurations.

To maintain data integrity and fault tolerance, the distributed computing platform may employ redundancy and replication mechanisms at multiple layers. Graph databases and time-series stores may replicate data across availability zones to protect against data loss. Compute nodes may be organized into failover pairs, with secondary nodes ready to assume the workload of a failed primary. Heartbeat signals exchanged between nodes may ensure timely detection of hardware or network failures, allowing automatic reassignment of tasks.

The computing system 900 may include a logging and monitoring subsystem that continuously collects metrics such as CPU utilization, memory usage, queue lengths, and transaction latencies. These metrics may be visualized using a monitoring dashboard and analyzed by an alerting service to detect anomalies. In some embodiments, logs may be stored in an immutable append-only ledger, allowing full traceability of system operations for compliance and audit purposes.

Security in the computing environment may be enforced through a multi-layered access-control model. Authentication may rely on OAuth® 2.0 or OpenID® Connect tokens, while authorization may be implemented via role-based policies. Each API call to the system may be logged and digitally signed, and sensitive data may be encrypted both in transit and at rest. The system may periodically rotate encryption keys and refresh tokens to minimize the risk of compromise.

To support interoperability with other utility systems, the computing environment may provide standardized data-exchange interfaces. These may include RESTful APIs, gRPC endpoints, and message-based protocols such as IEC 61968-9 (CIM-based data exchange). Each interface may expose services for querying graph topology, retrieving forecasts, or submitting control actions. The interfaces may conform to versioned schemas published by the platform, ensuring backward compatibility and stable integration with external applications.

In some embodiments, the computing environment may be deployed across a hybrid cloud infrastructure that combines on-premises and public cloud resources. The on-premises environment may host latency-sensitive applications such as SCADA integration and control dispatch, while the public cloud may host compute-intensive analytics and long-term data storage. A secure VPN or direct interconnect may link the two environments, ensuring data confidentiality and low latency.

From a software-architecture perspective, the computing system 900 may implement a domain-driven design. Core services, such as graph construction, analytics, and control, may be organized into bounded contexts that communicate through well-defined APIs. This modular architecture may allow independent development, testing, and scaling of each service without affecting others. Continuous integration and delivery pipelines may automate testing and deployment processes, reducing manual intervention and ensuring consistent system updates.

Furthermore, in operation, the computing system 900 may function as the computational backbone of the graph-based connectivity platform. It may orchestrate the ingestion, construction, validation, and analysis of large-scale electrical network models while providing real-time updates and decision support to grid operators. By leveraging distributed computing, high-performance memory management, container orchestration, and robust security protocols, the computing environment may ensure that the topological graph remains accurate, accessible, and reliable under continuous operational load.

Thus, the computing architecture illustrated in FIG. 9 provides a scalable, fault-tolerant, and secure infrastructure for executing the graph-based modeling and analytics techniques disclosed herein. It enables the described platform to operate effectively on modern utility-scale data volumes and to deliver high-speed, real-time decision-making capabilities for the management and optimization of electrical distribution systems.

The above description is merely a specific implementation of the present disclosure, but the scope of protection of the present disclosure is not limited thereto. Any person of ordinary skill in the art familiar with the technical field of the present disclosure can easily conceive various equivalent modifications or substitutions within the scope of the technology disclosed in the present disclosure, and such modifications or substitutions should be covered within the scope of protection of the present disclosure. Therefore, the scope of protection of the present disclosure should be determined by the scope of protection of the claims.

What is claimed is:

1. An electricity grid management system, comprising:
a processor; and
a memory, coupled to the processor, configured to store executable instructions that, when executed by the processor, cause the processor to:
ingest heterogeneous datasets describing electrical resources of a distribution network from a plurality of data sources including geographic information systems, customer information systems, interconnection applications, and telemetry streams;
canonicalize the ingested datasets into standardized resource objects each representing a physical or logical element of the distribution network, the resource objects including attributes defining at least a location, an electrical rating, and a connectivity identifier;
construct, using the resource objects, a topological graph including nodes representing electrical buses and edges representing electrical connections between the buses;
detect a plurality of disconnected subgraphs within the topological graph and merge the subgraphs based at least in part on geometric proximity and electrical phase compatibility to form a unified connected graph;
store the unified connected graph in a graph database accessible to one or more analytical and control services; and
dynamically update the unified connected graph responsive to telemetry events indicating a change in state of one or more switching devices in the distribution network.

2. The system of claim 1, wherein the processor is further configured to canonicalize each resource object according to a schema defining a unique identifier, coordinate reference system, voltage class, and phase configuration.

3. The system of claim 1, wherein constructing the topological graph comprises generating a geometrical graph using spatial coordinates of the resource objects and converting the geometrical graph to a topological graph by assigning electrical relationships independent of physical distance.

4. The system of claim 1, wherein merging the disconnected subgraphs comprises identifying, for each pair of subgraphs, nearest compatible node pairs having at least one shared electrical phase and connecting the node pairs based on a minimum-cost function that combines distance and phase compatibility metrics.

5. The system of claim 1, wherein the unified connected graph is stored in a graph database that is distributed across a plurality of compute nodes and stores the nodes and edges of the topological graph as partitioned datasets with version identifiers enabling rollback to previous configurations.

6. The system of claim 1, wherein dynamically updating the unified connected graph comprises modifying an edge connection state from closed to open or from open to closed responsive to a telemetry message indicating a change in switch status, and recomputing feeder connectivity in real time.

7. The system of claim 1, wherein the at least one processor is further configured to execute a validation routine that verifies an electrical feasibility of each merged connection by simulating a power-flow model using impedance data associated with the edges.

8. The system of claim 1, wherein the unified connected graph is accessible to analytical and control services including at least one of: an analytics service configured to compute network losses and feeder loading; a power-flow service configured to solve electrical equations using the topological graph; a forecast service configured to predict load and generation patterns; and a control service configured to issue operational commands to field devices.

9. The system of claim 1, wherein the at least one processor is further configured to maintain a temporal version chain of the topological graph, each version representing a distinct network topology generated by a switch-state change or data update.

10. The system of claim 1, further comprising an event-driven message bus, wherein the at least one processor is further configured to publish a graph update event to the message bus upon modification of the topological graph, causing subscribed analytical services to reload the updated graph.

11. The system of claim 1, wherein the at least one processor is further configured to generate a visualization of the topological graph in an operator dashboard, the visualization displaying node voltages, current flows, and switch positions updated in real time.

12. The system of claim 1, wherein the processor is further configured to execute a machine-learning model trained on historical network data to predict probable connections between subgraphs when explicit connectivity information is missing.

13. The system of claim 1, further comprising a security layer enforcing role-based access control, encryption of graph data at rest and in transit, and digital signing of update transactions.

14. The system of claim 1, wherein the processor is further configured to interface with an external power-distribution management system through an application programming interface exposing the topological graph in a machine-readable format.

15. The system of claim 1, wherein the at least one processor is further configured to perform parallelized graph-traversal computations across a distributed computing cluster to compute electrical distances, feeder reachability, or hosting-capacity metrics.

16. A computer-implemented method for electricity grid management, comprising:
receiving, by one or more processors, datasets describing grid components from a plurality of disparate data sources;
transforming the datasets into canonicalized resource objects representing electrical equipment and attributes of the resource objects;
constructing, from the resource objects, a topological graph representing electrical connectivity among grid nodes;
detecting multiple subgraphs within the topological graph and merging the subgraphs using geometric and electrical compatibility criteria; and
updating the unified topological graph responsive to switch-state telemetry to reflect a current operating topology.

17. The method of claim 16, further comprising validating each merged connection by executing a power-flow simulation and reverting merges that produce non-feasible electrical results.

18. The method of claim 16, further comprising receiving telemetry indicating an open or closed switch position and, based on the received telemetry, separating or joining feeders within the topological graph.

19. The method of claim 16, further comprising providing the unified topological graph as input to an analytics service configured to compute losses, reliability indices, and loading conditions, and to generate reports based on graph traversal computations.

20. The method of claim 16, further comprising generating a visual representation of the unified topological graph, wherein each node and edge is annotated with real-time electrical parameters obtained from field telemetry.
